(19) United States
(12) Patent Application Publication
(10) Pub. No.: US 2017/0052762 A1
(43) Pub. Date: Feb. 23, 2017

(54) SYSTEM AND METHOD FOR REPRESENTING COMPLEX NUMBERS IN FUSED FLOATING POINT

(71) Applicant: Futurewei Technologies, Inc., Plano, TX (US)

(72) Inventor: Alan Gatherer, Richardson, TX (US)

(21) Appl. No.: 14/831,673

(22) Filed: Aug. 20, 2015

(51) Int. Cl. G06F 7/483

(52) U.S. Cl. CPC G06F 7/483

(57) ABSTRACT

An apparatus is configured to perform a method that includes dividing a complex number into a real portion and an imaginary portion. The method also includes determining a region among a plurality of regions in a matrix based on a magnitude of the real portion and a magnitude of the imaginary portion, wherein each region of the plurality of regions includes three sub-regions. The method further includes determining a sub-region among the three sub-regions of the determined region based on the magnitude of the real portion and the magnitude of the imaginary portion. In addition, the method includes coding the real portion and the imaginary portion of the complex number using a common exponent, wherein the common exponent depends on the determined region and the coding depends on the determined sub-region. The method further includes storing the coded complex number in a memory that is accessible for communication signal processing

### TECHNICAL FIELD

The present disclosure relates generally to data storage, and more particularly, to a system and method for representing complex numbers in fused floating point.

### BACKGROUND

Throughout digital signal processing, complex numbers and arithmetic using complex numbers are widely used. For example, complex numbers are often used to perform modulation, encoding, and quantization of communication signals. Computers and computing devices often represent complex numbers using floating point. Floating point numbers have a mantissa component and an exponent component stored in a fixed number of bits. Depending on the size and desired precision of a number, the allocation of the fixed number of bits between the mantissa component and the exponent component can be different for different numbers.

### SUMMARY

According to one embodiment, a method is provided. The method includes dividing a complex number into a real portion and an imaginary portion. The method also includes determining a region among a plurality of regions in a matrix based on a magnitude of the real portion and a magnitude of the imaginary portion, wherein each region of the plurality of regions includes three sub-regions. The method further includes determining a sub-region among the three sub-regions of the determined region based on the magnitude of the real portion and the magnitude of the imaginary portion. In addition, the method includes coding the real portion and the imaginary portion of the complex number using a common exponent, wherein the common exponent depends on the determined region and the coding depends on the determined sub-region. The method further includes storing the coded complex number in a memory that is accessible for communication signal processing.

According to another embodiment, an apparatus is provided. The apparatus includes at least one memory configured to store complex numbers, and at least one processor coupled to the at least one memory. The at least one processor is configured to divide a complex number into a real portion and an imaginary portion; determine a region among a plurality of regions in a matrix based on a magnitude of the real portion and a magnitude of the imaginary portion, wherein each region of the plurality of regions includes three sub-regions; determine a sub-region among the three sub-regions of the determined region based on the magnitude of the real portion and the magnitude of the imaginary portion; code the real portion and the imaginary portion of the complex number using a common exponent, wherein the common exponent depends on the determined region and the coding depends on the determined sub-region; and store the coded complex number in the at least one memory.

According to yet another embodiment, there is provided a non-transitory computer readable medium embodying a computer program. The computer program includes computer readable program code for dividing a complex number into a real portion and an imaginary portion; determining a region among a plurality of regions in a matrix based on a magnitude of the real portion and a magnitude of the imaginary portion, wherein each region of the plurality of regions includes three sub-regions; determining a sub-region among the three sub-regions of the determined region based on the magnitude of the real portion and the magnitude of the imaginary portion; coding the real portion and the imaginary portion of the complex number using a common exponent, wherein the common exponent depends on the determined region and the coding depends on the determined sub-region; and storing the coded complex number in a memory that is accessible for communication signal processing.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example communication system that that may be used for implementing the devices and methods disclosed herein;

FIGS. 2A and 2B illustrate example devices that may implement the methods and teachings according to this disclosure;

FIG. 3 illustrates an example of a computing device that may implement the methods and teachings according to this disclosure;

FIG. 4 illustrates an example Vornoi group diagram for representation of complex numbers in floating point;

FIG. 5 illustrates a representation of complex numbers whose exact value can be stored in memory using floating point;

FIG. 6 illustrates an example Vornoi group diagram for representation of complex numbers in floating point where the real and imaginary components are quantized jointly, according to this disclosure;

FIG. 7 illustrates a representation of discrete complex numbers based on the Vornoi group diagram in FIG. 6, according to this disclosure;

FIG. 8 illustrates a flow diagram for fused floating point addition according to this disclosure;

FIG. 9 illustrates a flow diagram for fused floating point multiplication according to this disclosure;

FIG. 10 illustrates a method for representing complex numbers in fused floating point according to this disclosure.

### DETAILED DESCRIPTION

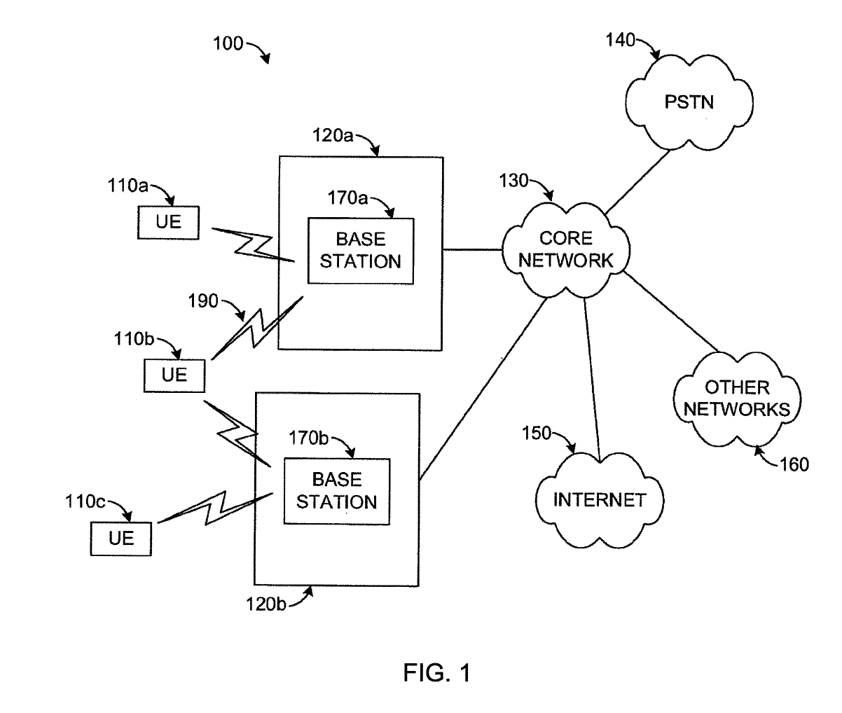

FIGS. 1 through 10, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example communication system 100 that may be used for implementing the devices and methods disclosed herein. In general, the system 100 enables multiple wireless users to transmit and receive data and other content. The system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) for wireless links such as communication links 190.

In this example, the communication system 100 includes user equipment (UE) 110a-110c, radio access networks (RANs) 120a-120b, a core network 130, a public switched telephone network (PSTN) 140, the Internet 150, and other networks 160. While certain numbers of these components or elements are shown in FIG. 1, any number of these components or elements may be included in the system 100. In some embodiments, only wireline networking links are used.

The UEs 110a-110c are configured to operate and/or communicate in the system 100. For example, the UEs 110a-110c are configured to transmit and/or receive wireless signals or wired signals. Each UE 110a-110c represents any suitable end user device and may include such devices (or may be referred to) as a user equipment/device (UE), wireless transmit/receive unit (WTRU), mobile station, fixed or mobile subscriber unit, pager, cellular telephone, personal digital assistant (PDA), smartphone, laptop, computer, touchpad, wireless sensor, or consumer electronics device.

The RANs 120a-120b here include base stations 170a-170b, respectively. Each base station 170a-170b is configured to wirelessly interface with one or more of the UEs 110a-110c to enable access to the core network 130, the PSTN 140, the Internet 150, and/or the other networks 160. For example, the base stations 170a-170b may include (or be) one or more of several well-known devices, such as a base transceiver station (BTS), a Node-B (NodeB), an evolved NodeB (eNodeB), a Home NodeB, a Home eNodeB, a site controller, an access point (AP), or a wireless router, or a server, router, switch, or other processing entity with a wired or wireless network.

In the embodiment shown in FIG. 1, the base station 170a forms part of the RAN 120a, which may include other base stations, elements, and/or devices. Also, the base station 170b forms part of the RAN 120b, which may include other base stations, elements, and/or devices. Each base station 170a-170b operates to transmit and/or receive wireless signals within a particular geographic region or area, sometimes referred to as a “cell.” In some embodiments, multiple-input multiple-output (MIMO) technology may be employed having multiple transceivers for each cell.

The base stations 170a-170b communicate with one or more of the UEs 110a-110c over one or more air interfaces 190 using wireless communication links. The air interfaces 190 may utilize any suitable radio access technology.

It is contemplated that the system 100 may use multiple channel access functionality, including such schemes as described above. In particular embodiments, the base stations and UEs may implement LTE, LTE-A, and/or LTE-B. Of course, other multiple access schemes and wireless protocols may be utilized.

The RANs 120a-120b are in communication with the core network 130 to provide the UEs 110a-110c with voice, data, application, Voice over Internet Protocol (VoIP), or other services. Understandably, the RANs 120a-120b and/or the core network 130 may be in direct or indirect communication with one or more other RANs (not shown). The core network 130 may also serve as a gateway access for other networks (such as PSTN 140, Internet 150, and other networks 160). In addition, some or all of the UEs 110a-110c may include functionality for communicating with different wireless networks over different wireless links using different wireless technologies and/or protocols.

Although FIG. 1 illustrates one example of a communication system, various changes may be made to FIG. 1. For example, the communication system 100 could include any number of UEs, base stations, networks, or other components in any suitable configuration.

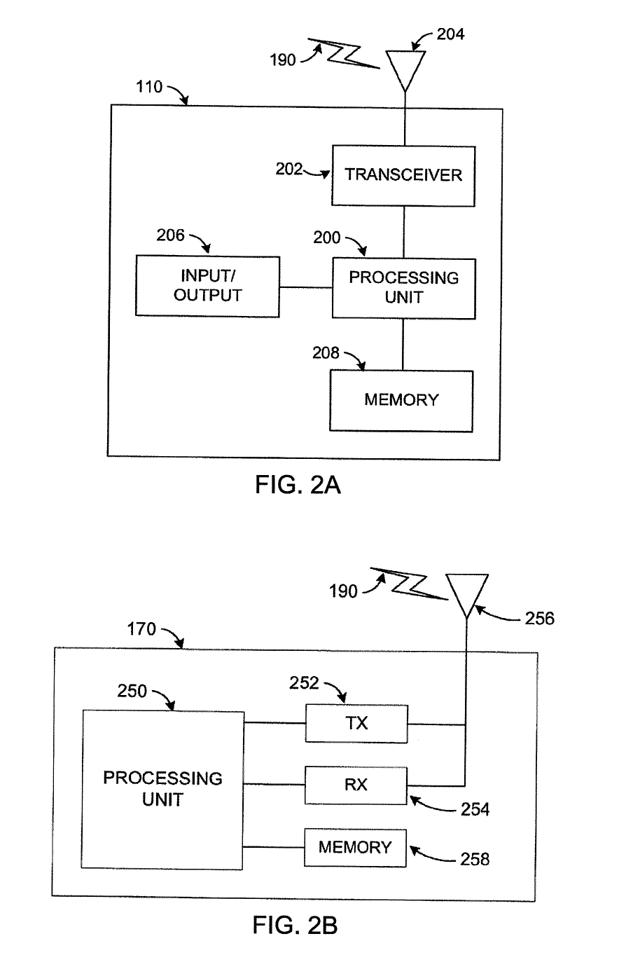

FIGS. 2A and 2B illustrate example devices that may implement the methods and teachings according to this disclosure. In particular, FIG. 2A illustrates an example UE 110 and FIG. 2B illustrates an example base station 170. These components could be used in the system 100, or in any other suitable system. In particular, these components could be configured for processing complex numbers in fused floating point, as described herein.

As shown in FIG. 2A, the UE 110 includes at least one processing unit 200. The processing unit 200 implements various processing operations of the UE 110. For example, the processing unit 200 could perform signal coding, data processing, power control, input/output processing, or any other functionality enabling the UE 110 to operate in the system 100. The processing unit 200 also supports the methods and teachings described in more detail herein. Each processing unit 200 includes any suitable processing or computing device configured to perform one or more operations. One or more processing units 200 could, for example, include a microprocessor, microcontroller, digital signal processor, field programmable gate array, system on chip (SoC), or application specific integrated circuit.

The UE 110 also includes at least one transceiver 202. The transceiver 202 is configured to modulate data or other content for transmission by at least one antenna 204. The transceiver 202 is also configured to demodulate data or other content received by the at least one antenna 204. Each transceiver 202 includes any suitable structure for generating signals for wireless transmission and/or processing signals received wirelessly. Each antenna 204 includes any suitable structure for transmitting and/or receiving wireless signals. One or multiple transceivers 202 could be used in the UE 110, and one or multiple antennas 204 could be used in the UE 110. Although shown as a single functional unit, a transceiver 202 could also be implemented using at least one transmitter and at least one separate receiver.

The UE 110 further includes one or more input/output devices 206. The input/output devices 206 facilitate interaction with a user. Each input/output device 206 includes any suitable structure for providing information to or receiving information from a user, such as a speaker, microphone, keypad, keyboard, display, or touch screen.

In addition, the UE 110 includes at least one memory 208. The memory 208 stores instructions and data used, generated, or collected by the UE 110. For example, the memory 208 could store software or firmware instructions executed by the processing unit(s) 200 and data used by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 2B, the base station 170 includes at least one processing unit 250, at least one transmitter 252, at least one receiver 254, one or more antennas 256, and at least one memory 258. The processing unit 250 implements various processing operations of the base station 170, such as signal coding, data processing, power control, input/output processing, or any other functionality. The processing unit 250 can also support the methods and teachings described in more detail herein. Each processing unit 250 includes any suitable processing or computing device configured to perform one or more operations. One or more processing units 250 could, for example, include a microprocessor, microcontroller, digital signal processor, field programmable gate array, system on chip (SoC), or application specific integrated circuit.

Each transmitter 252 includes any suitable structure for generating signals for wireless transmission to one or more UEs or other devices. Each receiver 254 includes any suitable structure for processing signals received wirelessly from one or more UEs or other devices. Although shown as separate components, at least one transmitter 252 and at least one receiver 254 could be combined into a transceiver. Each antenna 256 includes any suitable structure for transmitting and/or receiving wireless signals. While a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s).

Additional details regarding the UEs 110 and the base stations 170 are known to those of skill in the art. As such, these details are omitted here. It should be appreciated that the devices illustrated in FIGS. 2A and 2B are merely examples, and are not intended to be limiting. Various embodiments of this disclosure may be implemented using one or more computing devices that include the components of the UEs 110 and base stations 170, or which include an alternate combination of components, including components that are not shown in FIGS. 2A and 2B. For example, various embodiments of this disclosure may be implemented using a multi-processor computer, a plurality of single and/or multiprocessor computers arranged into a network, or some combination of both.

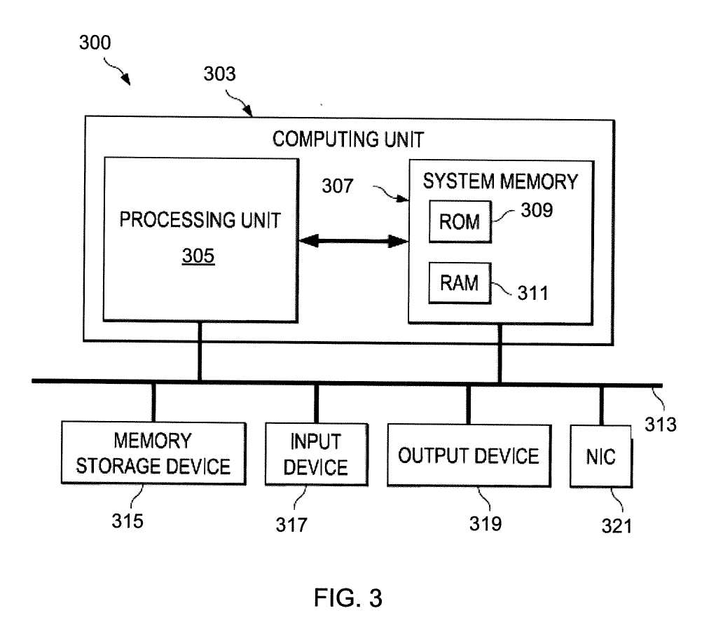

FIG. 3 illustrates an example of a computing device 300 that may implement the methods and teachings according to this disclosure. In some embodiments, the computing device 300 may represent all or portions of the UE 110 or the base station 170. In other embodiments, the computing device 300 may represent another type of device, such as a device that is not configured for wired or wireless communication. In particular, the computing device 300 could be configured for processing complex numbers in fused floating point, as described herein.

As shown in FIG. 3, the computing device 300 includes a computing block 303 with a processing block 305 and a system memory 307. The processing block 305 may be any type of programmable electronic device for executing software instructions, but will conventionally be one or more microprocessors. The system memory 307 may include both a read-only memory (ROM) 309 and a random access memory (RAM) 311. As will be appreciated by those of skill in the art, both the read-only memory 309 and the random access memory 311 may store software instructions for execution by the processing block 305.

The processing block 305 and the system memory 307 are connected, either directly or indirectly, through a bus 313 or alternate communication structure, to one or more peripheral devices. For example, the processing block 305 or the system memory 307 may be directly or indirectly connected to one or more additional memory storage devices 315. The memory storage devices 315 may include, for example, a “hard” magnetic disk drive, a solid state disk drive, an optical disk drive, and a removable disk drive. The processing block 305 and the system memory 307 also may be directly or indirectly connected to one or more input devices 317 and one or more output devices 319. The input devices 317 may include, for example, a keyboard, a pointing device (such as a mouse, touchpad, stylus, trackball, or joystick), a touch screen, a scanner, a camera, and a microphone. The output devices 319 may include, for example, a display device, a printer and speakers. Such a display device may be configured to display video images. With various examples of the computing device 301, one or more of the peripheral devices 315-319 may be internally housed with the computing block 303. Alternately, one or more of the peripheral devices 315-319 may be external to the housing for the computing block 303 and connected to the bus 313 through, for example, a Universal Serial Bus (USB) connection or a digital visual interface (DVI) connection.

With some implementations, the computing block 303 may also be directly or indirectly connected to one or more network interfaces cards (NIC) 321, for communicating with other devices making up a network. The network interface cards 321 translate data and control signals from the computing block 303 into network messages according to one or more communication protocols, such as the transmission control protocol (TCP) and the Internet protocol (IP). Also, the network interface cards 321 may employ any suitable connection agent (or combination of agents) for connecting to a network, including, for example, a wireless transceiver, a modem, or an Ethernet connection.

It should be appreciated that the computing device 300 is illustrated as an example only, and it not intended to be limiting. Various embodiments of this disclosure may be implemented using one or more computing devices that include the components of the computing device 300 illustrated in FIG. 3, or which include an alternate combination of components, including components that are not shown in FIG. 3. For example, various embodiments of the invention may be implemented using a multi-processor computer, a plurality of single and/or multiprocessor computers arranged into a network, or some combination of both.

In standard floating point notation, complex or imaginary numbers are represented as a mantissa times 2 to an exponent e. The mantissa is typically of the form ‘1.xxxxxx’, where xxxxxx represents one or more binary bits representing a fractional number to the right of the point. The storage bits store the one or more numbers to the right of the point. The ‘1’ to the left of the point does not need to be stored, because it is always represents the number one, to which the fractional part is added; thus it can be implicit. The number zero and certain other special numbers (e.g., “NAN” (not a number), overflow, underflow, etc.) may have a special representation because these numbers are not representable in standard floating point notation.

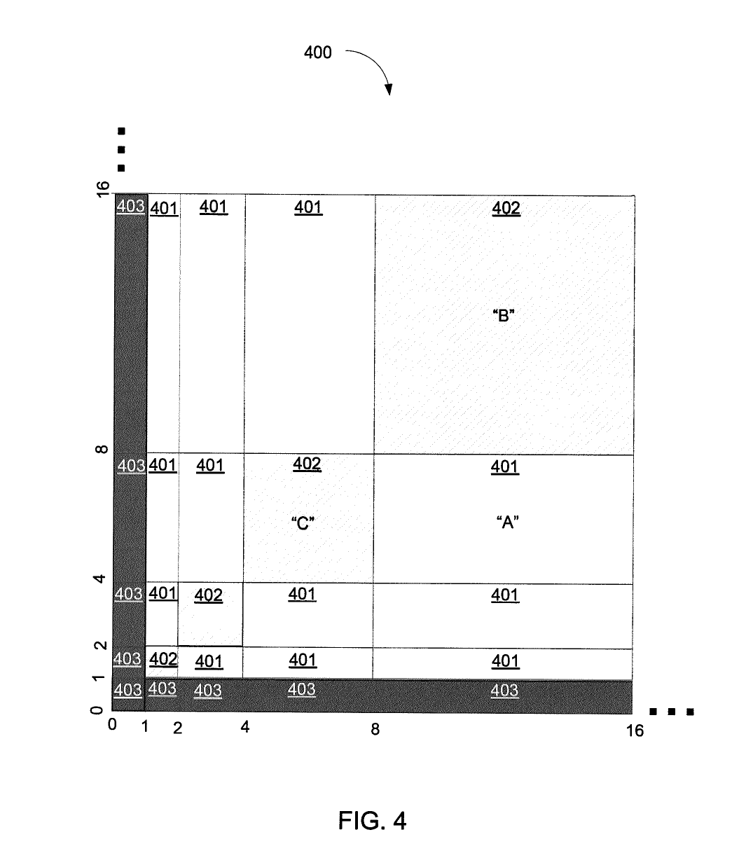

FIG. 4 illustrates an example Vornoi group diagram for representation of complex numbers in floating point. In the Vornoi group diagram 400, the X axis represents the real portion of a complex number and the Y axis represents the imaginary portion of a complex number. Thus, for a complex number a+jb, a is represented in the X direction and b is represented in the Y direction. Although only numbers up to 16 are shown in the Vornoi group diagram 400, it will be understood that the Vornoi group diagram 400 extends in both the X and Y directions to encompass larger numbers. The Vornoi group diagram 400 may extend in the negative X and negative Y directions, as well.

The Vornoi group diagram 400 includes a plurality of Vornoi groups 401-403. Each Vornoi group 401-403 includes multiple Vornoi regions. In general, a Vornoi region is a region around a point that is closer to the given point than any other selected point. In the Vornoi group diagram 400, each Vornoi group 401-403 represents complex numbers whose real and imaginary components are quantized and stored in memory using a consistent arrangement of bits. For example, the Vornoi group 401 indicated with an “A” includes complex numbers a+jb, where a is between 8 and 16, and b is between 4 and 8. In most floating point systems, numbers between 8 and 16 are stored in memory in a consistent arrangement, with an exponent e=3, while numbers between 4 and 8 are stored in memory in another consistent arrangement, with an exponent e=2.

Thus, each Vornoi group 401-403 is bounded by the exponent for the real portion of the complex number and the exponent for the imaginary portion of the complex number. For example, all of the real numbers having an exponent 0 fall between the vertical lines 1 and 2. All of the imaginary numbers having an exponent 1 fall between the horizontal lines 2 and 4. Complex numbers can have real and imaginary portions with different exponents. Or complex numbers can have real and imaginary portions with same exponent. The complex numbers having real and imaginary portions with same exponent are located in one of the Vornoi groups 402 that fall along a 45 degree angle between the X and Y axes. Together, the Vornoi groups 403 represent an undefined region in which numbers cannot be represented using standard floating point notation.

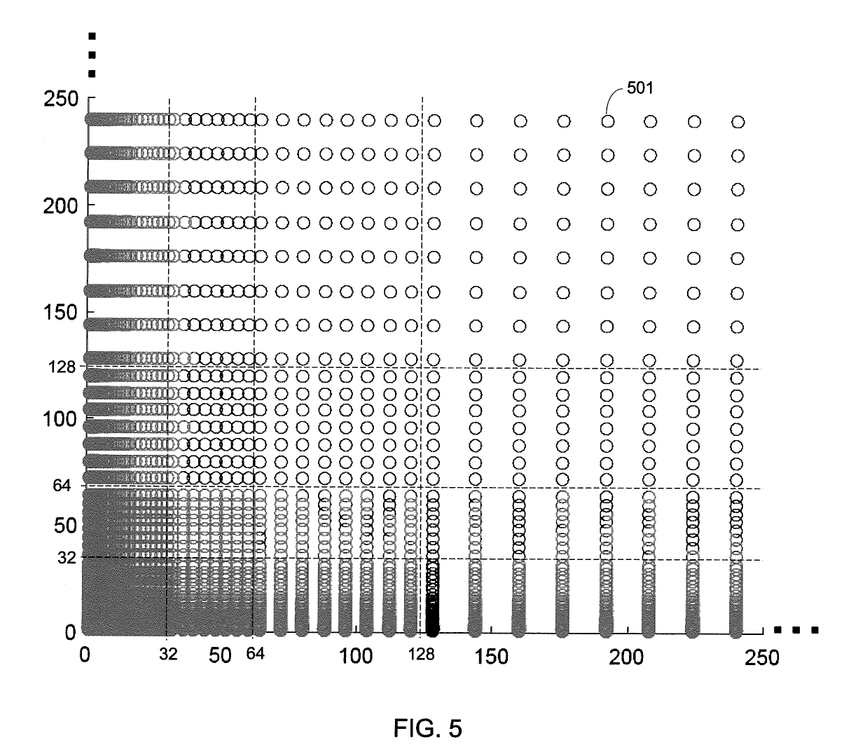

FIG. 5 illustrates a representation of complex numbers whose exact value can be stored in memory using floating point. As shown in FIG. 5, each circle 501 represents a particular complex number that can be represented exactly using a floating point number with a finite number of bits for storage. For example, using a 16 bit floating point representation, only a set of 2¹⁶=65,536 particular numbers can be represented exactly. All other numbers must be quantized (e.g., rounded) to one of the 65,536 numbers that can be represented exactly. Stated another way, the circles 501 represent the quantization of the complex number space. As with FIG. 4, the X axis in FIG. 5 represents the real portion of a complex number and the Y axis represents the imaginary portion of a complex number. In floating point, quantization error of a number depends on how far away from the origin the number is. Numbers closer to the origin have much finer quantization than numbers far away from the origin.

The circles 501 are arranged in regions defined by dashed lines, as shown in FIG. 5. For clarity, not all dashed lines are shown, since the dashed lines get progressively closer together towards the axes. Each region corresponds to a particular Vornoi group 401-403 in FIG. 4. As shown in FIG. 5, there is a very regular tessellation of circles 501 within each region because the circles 501 are represented by the mantissa for the real portion and the mantissa for the imaginary portion of a given complex number. Thus, within each region, the real and imaginary portions are regularly spaced in the X direction and are regularly spaced in the Y direction. However, because certain regions have a different scale in the X direction than in the Y direction (i.e., the region may be rectangular rather than square), the spacing or distance between adjacent circles 501 in the X direction may be different than the spacing or distance between adjacent circles 501 in the Y direction. Thus, for some of the regions shown in FIG. 5, there is an asymmetry to the spacing of the points when comparing the X direction and the Y direction.

For a given value somewhere in the complex number space, that value can be represented in the complex number representation shown in FIG. 5. In particular, to represent a particular value, the closest circle 501 to the actual value can be selected, and that closest circle 501 can then be used as a representation of the actual value. Stated differently, for a quantized representation of a complex number in FIGS. 4 and 5, the Vornoi region that the actual complex number falls into is determined, and then that Vornoi region and its designated circle 501 is used to approximate the actual number. The quantization error represents the distance from the actual value to the selected closest circle 501.

As shown in FIG. 4, the Vornoi groups 402 that fall along a 45 degree angle between the X and Y axes share a characteristic: the complex numbers represented within the Vornoi groups 402 have real and imaginary components that have the same exponent. For example, for any complex number that falls with the Vornoi group 402 indicated with a “B”, the exponent e for the real portion of the number is 3, and the exponent e for the imaginary portion of the number is also 3. Likewise, for any complex number that falls with the Vornoi group 402 indicated with a “C”, the real and imaginary components of the number have the same exponent e=2.

In contrast, in the Vornoi groups 401, the represented complex numbers have real and imaginary components with different exponents. For example, in the Vornoi group 401 indicated with an “A”, a complex number has a real portion with an exponent e=3 and an imaginary portion with an exponent e=2. Thus, for most complex numbers, the real and imaginary portions of the number have different quantization error. The separate quantization results in a larger number of bits used for storage and arithmetic of complex numbers.

In addition to requiring a larger number of representational bits, the representation scheme shown in FIGS. 4 and 5 is characterized by varying levels of resolution. As shown in FIG. 4, the Vornoi groups 402 that fall along a 45 degree angle between the X and Y axes are substantially square. In the corresponding regions in FIG. 5, the spacing between adjacent circles 501 in the X direction is substantially the same as the spacing between adjacent circles 501 in the Y direction. Stated differently, the resolution in the X direction is substantially the same as the resolution in the Y direction. Further away from the 45 degree line and towards either the X axis or Y axis, the Vornoi groups 401 become increasingly rectangular, with one dimension increasingly larger than the other dimension. The resolution difference between the X direction and the Y direction can be clearly seen in the spacing of the circles 501 near the X and Y axes, where adjacent circles are close together in one direction, but spaced apart in an orthogonal direction.

The varying resolution in the representation scheme shown in FIGS. 4 and 5 can also be considered with respect to polar coordinates. That is, rather than using an X,Y coordinate system, the Vornoi group diagram 400 and the complex number representation in FIG. 5 can be considered using a polar coordinate system, where each point is associated with an amplitude (or distance) and an angle (or phase). Based on a polar coordinate system, it can be seen in FIGS. 4 and 5 that close to the X axis, the real component of a complex number mostly represents the amplitude of the complex number. Likewise, close to the X axis, the imaginary component mostly represents the phase of the complex number; here, the resolution in the Y direction is much higher. In contrast, close to the Y axis, the imaginary component of a complex number mostly represents the amplitude of the complex number.

Close to the X and Y axes, the angular resolution is high, as indicated by the closely spaced circles 501 in FIG. 5. However, closer to the 45 degree line, the angular resolution is much lower, as indicated by the more widely space circles 501. Because of the lower angular resolution at some angles, any benefit in complex number arithmetic resulting from the higher angular resolution near the X and Y axes is mostly lost to the average performance of the number representation and is completely lost to the worst case performance of the representation. This is especially important for communication systems where the angle of rotation of the complex number may be initially unknown (until it is corrected using estimation) and the information in the signal is spread evenly across the angular space. For example, a quadrature amplitude modulation (QAM) constellation (e.g., 64-QAM) is known to be sensitive to angular error.

To address these and other issues, the embodiments disclosed herein provide a complex number representation that provides a joint coding of the exponents of the real and imaginary portions, while also providing a more consistent angular resolution for all numbers.

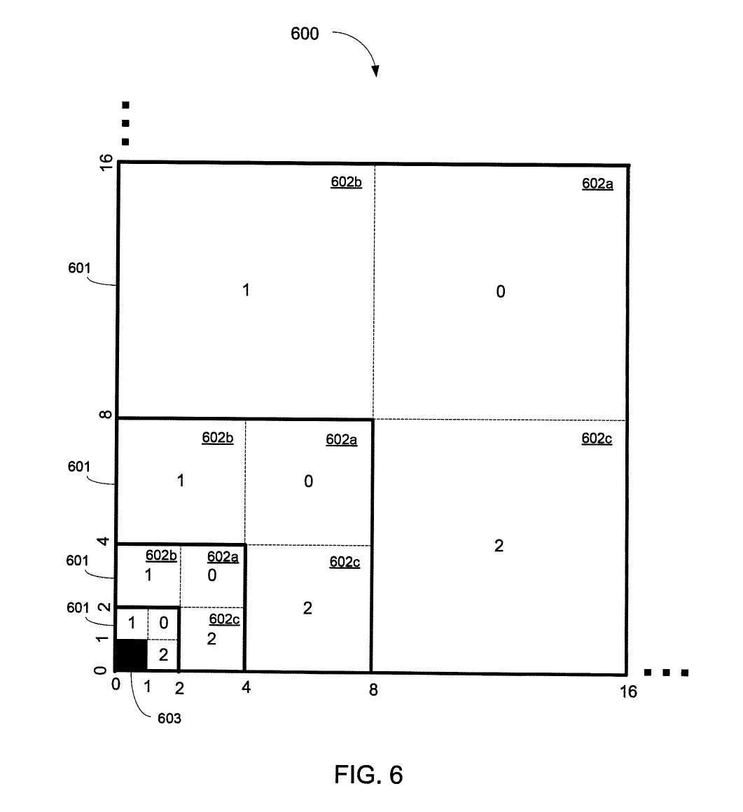

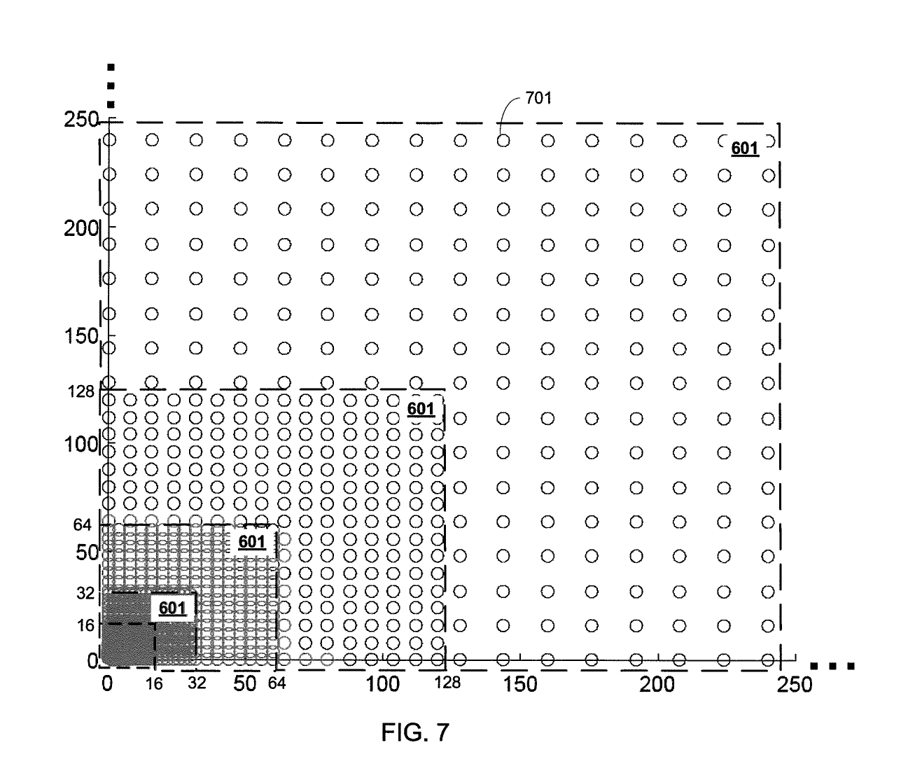

FIG. 6 illustrates an example Vornoi group diagram for representation of complex numbers in floating point where the real and imaginary components are quantized jointly, according to this disclosure. FIG. 7 illustrates a representation of discrete complex numbers based on the Vornoi group diagram 600 in FIG. 6, according to this disclosure.

The Vornoi group diagram 600 may be considered a two-dimensional matrix for representation of complex numbers. In the Vornoi group diagram 600, the X axis represents the real portion of a complex number and the Y axis represents the imaginary portion of a complex number. Although only numbers up to 16 are shown in the Vornoi group diagram 600, it will be understood that the Vornoi group diagram 600 extends in both the X and Y directions to encompass larger numbers. The Vornoi group diagram 600 may extend in the negative X and negative Y directions, as well.

The Vornoi group diagram 600 includes a plurality of L-shaped Vornoi groups 601 outlined in heavy bold lines. Moving away from the origin, the Vornoi groups 601 increase in size. Each Vornoi group 601 is divided into three sub-regions 602a-602c. Within each Vornoi group 601, there is a regularly spaced arrangement of circles 701, as shown in FIG. 7. Similar to the circles 501 in FIG. 5, the circles 701 represent the mantissas of the real and imaginary portions of a discrete complex number. However, there are a number of important differences between FIG. 5 and FIG. 7. In FIG. 5, the Y direction resolution of the circles 501 increases as the X axis is approached, and the X direction resolution of the circles 501 increases as the Y axis is approached. In contrast, in FIG. 7, the circles 701 are evenly spaced in both directions and are encoded by the mantissas of the real and imaginary portions. That is, the X and Y resolutions of the circles 701 remain constant throughout each Vornoi group 601. Stated another way, for a given Vornoi group 601, the resolution is the same in all three sub-regions 602a-602c. This constant resolution allows the encoding of a complex number that falls in a sub-region 602b or 602c to be similar to an encoding of a complex number that falls in a sub-region 602a, as described below. The encoding includes a new 2-bit field in the number representation, referred to as “scale” or s for short.

In FIG. 6, the sub-regions 602a are analogous to the Vornoi groups 402 of FIG. 4, in that complex numbers within the sub-regions 602a have a common exponent e for both the real and imaginary portions. Thus, complex numbers within the sub-regions 602a can be jointly coded with a common exponent e for the real and imaginary portions, which saves representational bits. While complex numbers within sub-regions 602b-602c would typically have different exponents for the real and imaginary portions when represented in standard floating point, the constant resolution of the sub-regions 602a-602c and following coding technique allow these complex numbers within sub-regions 602b-602c to be coded using a common exponent e as well.

The coding technique can be referred to as fused floating point, and is described as follows. For each Vornoi group 601, the corresponding sub-regions 602a-602c are indexed with an index value s, where s=0, 1, or 2. For example, each sub-region 602a is indexed with a 0; each sub-region 602b is indexed with a 1; and each sub-region 602c is indexed with a 2. The associated index uses 2 extra bits to be stored in memory. Each L shaped Vornoi group 601 is associated with a common exponent e (e.g., e=2 in the Vornoi group 601 between 2 and 4). For a given complex number n to be encoded, the mantissas of the real and imaginary portions, mᵣ and mᵢ, are encoded linearly and independently as usual with the format 1.xxxxx. Then, depending on where the complex number falls in the Vornoi group diagram 600, the Vornoi group 601 and the associated sub-region 602a-602c within the Vornoi group 601 can be determined. The Vornoi group 601 determines the exponent e to be used in the encoding, and the sub-region 602a-602c determines the index value s to be used in the encoding. Thus, the encoded exponent component includes the common exponent e for both the real and imaginary portions, and the 2-bit index value s.

For a given exponent e, index value s, and real and imaginary mantissas mᵣ and mᵢ, a complex number n can be determined as follows:

When s=0, n=(mᵣ+jmᵢ)2^{e}. (1)

Here, n is a number located in a sub-region 602a of a Vornoi group 601.

When s=1, n=((mᵣ−1)+jmᵢ)2^{e}. (2)

Here, n is a number located in a sub-region 602b of a Vornoi group 601.

When s=2, n=(mᵣ+j(mᵢ−1))2^{e}. (3)

Here, n is a number located in a sub-region 602c of a Vornoi group 601.

Due to the common resolution throughout a Vornoi group 601, the number of bits used to represent the mantissas mᵣ and mᵢ is the same. Thus, there is the same quantization or tessellation within each of the sub-regions 602a-602c. The subtraction of 1 in Equations (2) and (3) moves the mantissa left or down from the sub-region 602a (i.e., the ‘0’ sub-region) to either the sub-region 602b or the sub-region 602c. For example, the subtraction of 1 from mᵣ moves the mantissa left from the sub-region 602a to the sub-region 602b (i.e., the ‘1’ sub-region). Similarly, the subtraction of 1 from mᵢ moves the mantissa down from the sub-region 602a to the sub-region 602c (i.e., the ‘2’ sub-region). This encoding has some interesting features.

There is a small undefined region 603 below 1 for both mantissas, but the undefined region 603 does not extend out to infinity along the axes as it does in FIG. 4. Instead, the undefined region 603 is a small square at the origin. Thus, as the Vornoi groups 601 get larger moving away from the origin, the mantissa coding gets more spread out. However, numbers down to zero can be coded most of the way along the axes (except for the undefined region 603). In some embodiments, index value s=3 can be used to encode numbers in the undefined region 603, such as 0 (0+0j) without requiring a special encoding for zero.

The resolution in each L-shaped Vornoi group 601 is the same all the way through the Vornoi group 601. Stated another way, the tessellation of points is the same in the sub-regions 602b-602c as it is in the sub-region 602a. As a result, the angular resolution is as nearly the same close to the X and Y axes as it is near the 45 degree line. This is similar to a “polar coordinates” coding of the complex number, where the magnitude is coded logarithmically and the angle is coded linearly. This similarity is very important for communication systems where the signal requires angular resolution to be accurately decoded but needs a floating point resolution on the magnitude. Frequently, the signal is multiplied by a channel that varies its amplitude quite a bit, and it is the relative amplitude of signal to noise that is important.

While the index values disclosed herein are described as being 0, 1, 2, and 3, those of skill in the art will recognize that this is merely one example. Other values could be used, or the values could be rearranged to associate with different coding scenarios.

Computational Complexity

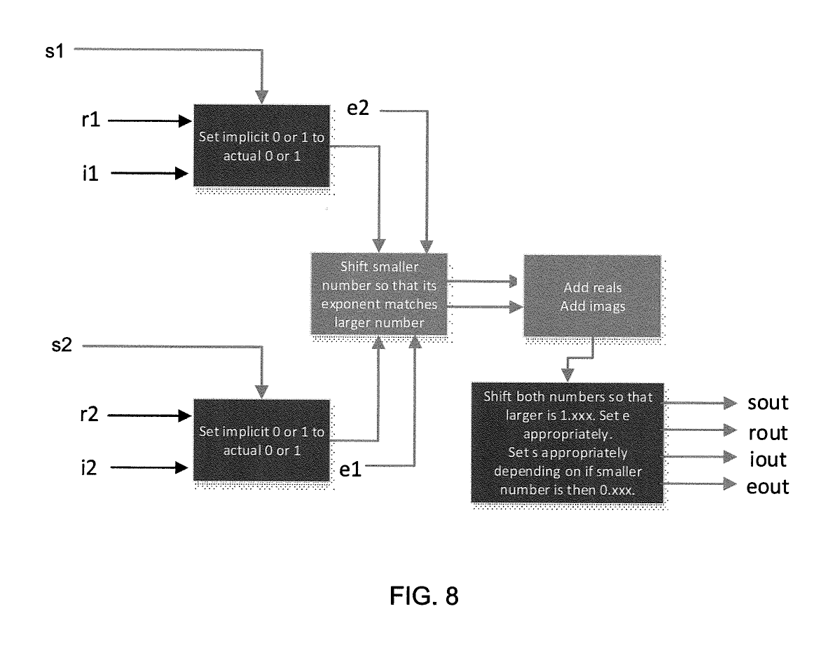

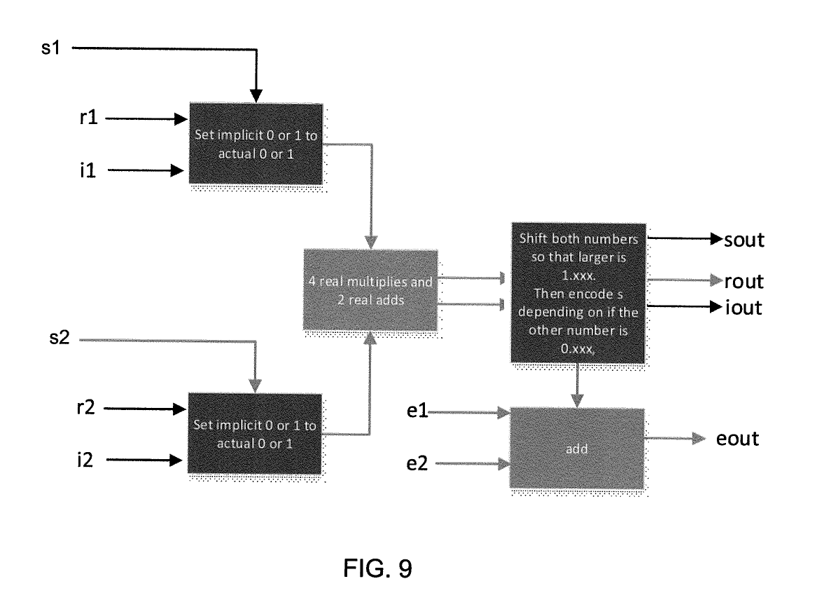

FIG. 8 illustrates a flow diagram for fused floating point addition according to this disclosure. FIG. 9 illustrates a flow diagram for fused floating point multiplication according to this disclosure. As can be seen in FIGS. 8 and 9, arithmetic addition or multiplication using the disclosed coding technique is effectively very similar to standard floating point computational methods. In FIGS. 8 and 9, r, i, s, and e refer to the real portion, imaginary portion, index value s, and exponent, respectively, for each number in the arithmetic operation; 1 and 2 refer to the first and second number in the arithmetic operation. Thus, e.g., r2 is the real portion of the second number that is being added or multiplied in the arithmetic operation.

Mantissa addition and multiplication is very similar to standard floating point because the subtraction of 1 as disclosed above is just a drop of an implicit bit before the calculation. Once the result is computed, the real and imaginary portions are normalized in a manner very similar to standard floating point, except the real and imaginary portions are allowed to be one bit shift different from each other. This is permitted by the index value s. This is a minimal change from conventional computational methods.

As shown in the addition process in FIG. 8, there is a trivial setting of the implicit bit at the start, and then a shifting of the result to get both numbers to the same exponent. This can be performed separately for the real and imaginary portions, just like in unfused addition. Then, the addition process is performed similar to standard floating point addition, which comprises most of the operations. The final shift is a little different as the result is aligned to a common exponent, and then the s bit is set appropriately. In contrast, in standard addition, there are two shifts and exponent adjustments, but no setting of the s bit.

As shown in FIG. 9, multiplication using the disclosed coding technique is performed depending on the value of s, but does not require any more multiplication operations than standard floating point.

When s=0 for either of the input numbers, a standard fixed point multiplication is performed with a single exponent addition, then normalization.

When s=1 or s=2, the relevant mantissa is first shifted to the right (maintaining the resolution in the multiplication using extra resolution bits if desired). Then the multiplication reverts to a standard fixed point multiplication.

The result is then normalized by picking the biggest exponent of the 2 mantissas and then shifting the other mantissa to the left by one if it has a smaller exponent, before rounding to the mantissa length.

Thus, the primary difference between the multiplication process shown in FIG. 9 and standard fixed point multiplication is in the trivial setting of the implicit bit at the start and then the way the result is shifted after multiplication, which only involves one shift step (due to the common exponent) and then a setting of the s bits. The main mantissa multiplication step is unaffected.

Exponent normalization for multiplication using the disclosed coding technique is performed the same as, or similar to, standard floating point computational methods. Exponent normalization for addition using the disclosed coding technique is actually a little easier, since there is a common exponent, and the normalization only needs to be performed once, not twice.

Storage Considerations

The required memory storage for conventional coding using separate exponents (such as in standard floating point) is 2lₑ+2lₘ bits, where lₑ represents the length of the exponent and lₘ represents the length of the mantissa. In some coding techniques, lₘ may also include one bit for the sign of the mantissa. In contrast, the required memory storage for coding using the disclosed coding technique with a common exponent is 2+lₑ+2lₘ bits, where the standalone 2 represents 2 bits used for the index value s.

It can be seen, then, that the disclosed coding technique can reduce memory requirements. As an example, in some computational systems, lₑ=5 and lₘ=11. Using separate exponents and conventional coding takes 2(5)+2(11)=32 bits, while the disclosed coding technique with the common exponent takes only 2+5+2(11)=29 bits, for a 9% savings in memory for similar accuracy.

In some embodiments, it may not be practical to store a 29-bit number, since memory storage is typically in multiples of 8 bits. However, the 29-bit result is merely one example. In other embodiments, lₑ and lₘ may have other values that would result in a practical storage arrangement with memory savings.

Alternatively, if memory saving is not as important, but more dynamic range or better performance is desired, then the disclosed coding technique provides other advantages. For example, in some embodiments, real number storage can be maintained at 16 bits storage with lₑ=5 and lₘ=11, but complex numbers are given greater dynamic range by setting lₑ=6 and lₘ=12. The increase in lₑ and lₘ increases the dynamic range (i.e., more L shaped Vornoi groups 601) as well as the resolution (i.e., more circles 701 per Vornoi group 601), while still using only 32 bits of storage. Therefore, substantially higher accuracy can be expected in the calculations.

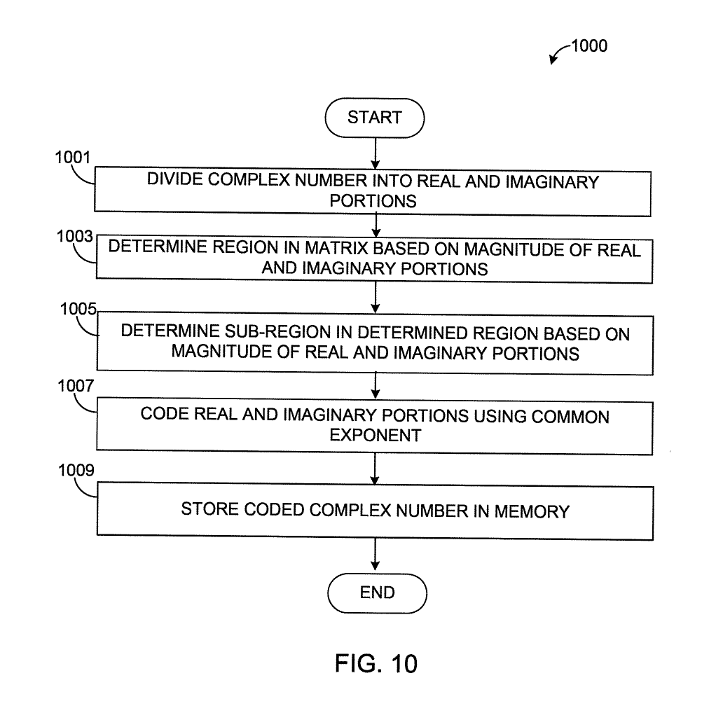

FIG. 10 illustrates a method for processing complex numbers in fused floating point according to this disclosure. The method 1000 shown in FIG. 10 is based on the key concepts described above. The method 1000 may be performed in association with the UE 110 of FIG. 2A, the base station 170 of FIG. 2B, or the computing device 300 of FIG. 3. However, the method 1000 could also be used with any other suitable device or system.

Initially, at operation 1001, a complex number is divided into a real portion and an imaginary portion. At operation 1003, a region is determined among a plurality of regions in a matrix based on a magnitude of the real and imaginary portions of the complex number. The matrix may be associated with the Vornoi group diagram 600 or the representation of discrete complex numbers in FIG. 7. Each region of the plurality of regions in the matrix includes three sub-regions. In some embodiments, each region in the matrix is an L-shaped region and each of the three sub-regions of the region is rectangular. In some embodiments, each sub-region is identified by an index value s, wherein s=0, 1, or 2.

At operation 1005, a sub-region is determined among the three sub-regions of the determined region based on the magnitude of the real portion and the magnitude of the imaginary portion. After that, at operation 1007, the real portion and the imaginary portion of the complex number are coded using a common exponent. The common exponent depends on the determined region and the coding depends on the determined sub-region. The complex number may be determined according using one of Equations (1) through (3) discussed above. Later, at operation 1009, the coded complex number is stored in a memory where it can be used for multiple different applications, including communication signal processing.

Although FIG. 10 illustrates one example of a method 1000 for processing complex numbers in fused floating point, various changes may be made to FIG. 10. For example, while shown as a series of steps, various steps shown in FIG. 10 could overlap, occur in parallel, occur in a different order, or occur multiple times. Moreover, some steps could be combined or removed and additional steps could be added according to particular needs.

Compared to standard floating point storage, coding, and arithmetic techniques, the embodiments disclosed herein provide at least as good accuracy and resolution while providing storage savings, or provide better accuracy and resolution using the same storage. The disclosed embodiments provide angular resolution that is substantially the same all over the matrix. This means that the phase and amplitude are represented with approximately the same accuracy at all angles.

Also, the disclosed embodiments provide a way to represent purely imaginary or purely real numbers that have a magnitude greater than 1. That is, the undefined zone is much smaller. Moreover, in some embodiments, index value s=3 can be used to encode numbers in the undefined region 603, such as 0 (0+0j) without requiring a special encoding for zero.

The disclosed embodiments can be used wherever complex number arithmetic is performed. In particular, the disclosed embodiments have applications in quadrature amplitude modulation (QAM) schemes in wireless communications.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for communication signal processing, the method comprising:
dividing a complex number into a real portion and an imaginary portion;
determining a region among a plurality of regions in a matrix based on a magnitude of the real portion and a magnitude of the imaginary portion, wherein each region of the plurality of regions includes three sub-regions;
determining a sub-region among the three sub-regions of the determined region based on the magnitude of the real portion and the magnitude of the imaginary portion;
coding the real portion and the imaginary portion of the complex number using a common exponent, wherein the common exponent depends on the determined region and the coding depends on the determined sub-region; and
storing the coded complex number in a memory that is accessible for communication signal processing.

2. The method of claim 1, wherein the matrix is a two-dimensional matrix, a first dimension of the matrix is associated with the real portion of the complex number, and a second dimension of the matrix is associated with the imaginary portion of the matrix.

3. The method of claim 1, wherein each region in the matrix is an L-shaped region and each of the three sub-regions of the region is rectangular.

4. The method of claim 3, wherein each sub-region is identified by an index value s, wherein s=0, 1, or 2.

5. The method of claim 4, further comprising:
determining the complex number according to one of the following:
when s=0, n=(mᵣ+jmᵢ)2^{e};
when s=1, n=((mᵣ−1)+jmᵢ)2^{e}; or
when s=2, n=(mᵣ+j(mᵢ−1))2^{e};
where n is the complex number, s is the index value of the sub-region, mᵣ and mᵢ are mantissas of the real and imaginary portions of the complex number, and e is the common exponent.

6. The method of claim 1, further comprising:
modulating a communication signal using the coded complex number.

7. An apparatus for communication signal processing, the apparatus comprising:
at least one memory configured to store complex numbers; and
at least one processor coupled to the at least one memory, the at least one processor configured to:
divide a complex number into a real portion and an imaginary portion;
determine a region among a plurality of regions in a matrix based on a magnitude of the real portion and a magnitude of the imaginary portion, wherein each region of the plurality of regions includes three sub-regions;
determine a sub-region among the three sub-regions of the determined region based on the magnitude of the real portion and the magnitude of the imaginary portion;
code the real portion and the imaginary portion of the complex number using a common exponent, wherein the common exponent depends on the determined region and the coding depends on the determined sub-region; and
store the coded complex number in the at least one memory.

8. The apparatus of claim 7, wherein the matrix is a two-dimensional matrix, a first dimension of the matrix is associated with the real portion of the complex number, and a second dimension of the matrix is associated with the imaginary portion of the matrix.

9. The apparatus of claim 7, wherein each region in the matrix is an L-shaped region and each of the three sub-regions of the region is rectangular.

10. The apparatus of claim 9, wherein each sub-region is identified by an index value s, wherein s=0, 1, or 2.

11. The apparatus of claim 10, wherein the at least one processor is further configured to:
determine the complex number according to one of the following:
when s=0, n=(mᵣ+jmᵢ)2^{e};
when s=1, n=((mᵣ−1)+jmᵢ)2^{e}; and
when s=2, n=(mᵣ+j(mᵢ−1))2^{e};
where n is the complex number, s is the index value of the sub-region, mᵣ and mᵢ are mantissas of the real and imaginary portions of the complex number, and e is the common exponent.

12. The apparatus of claim 7, wherein the at least one processor is further configured to:
modulate a communication signal using the coded complex number.

13. A non-transitory computer readable medium embodying a computer program, the computer program comprising computer readable program code for:
dividing a complex number into a real portion and an imaginary portion;
determining a region among a plurality of regions in a matrix based on a magnitude of the real portion and a magnitude of the imaginary portion, wherein each region of the plurality of regions includes three sub-regions;
determining a sub-region among the three sub-regions of the determined region based on the magnitude of the real portion and the magnitude of the imaginary portion; and
coding the real portion and the imaginary portion of the complex number using a common exponent, wherein the common exponent depends on the determined region and the coding depends on the determined sub-region; and
storing the coded complex number in a memory that is accessible for communication signal processing.

14. The non-transitory computer readable medium of claim 13, wherein the matrix is a two-dimensional matrix, a first dimension of the matrix is associated with the real portion of the complex number, and a second dimension of the matrix is associated with the imaginary portion of the matrix.

15. The non-transitory computer readable medium of claim 13, wherein each region in the matrix is an L-shaped region and each of the three sub-regions of the region is rectangular.

16. The non-transitory computer readable medium of claim 15, wherein each sub-region is identified by an index value s, wherein s=0, 1, or 2.

17. The non-transitory computer readable medium of claim 16, the computer program further comprising computer readable program code for:
determining the complex number according to one of the following:
when s=0, n=(mᵣ+jmᵢ)2^{e};
when s=1, n=((mᵣ−1)+jmᵢ)2^{e}; and
when s=2, n=(mᵣ+j(mᵢ−1))2^{e};
where n is the complex number, s is the index value of the sub-region, mᵣ and mᵢ are mantissas of the real and imaginary portions of the complex number, and e is the common exponent.

18. The non-transitory computer readable medium of claim 13, the computer program further comprising computer readable program code for:
modulating a communication signal using the coded complex number.
